(19) United States
(12) Patent Application Publication
(10) Pub. No.: US 2012/0006794 A1
(43) Pub. Date: Jan. 12, 2012

(54) METAL CONNECTING METHOD AND METAL CONNECTING DEVICE

(75) Inventors: Kazuhiro Murakami, Susono-shi (JP); Yoshihiko Watanabe, Susono-shi (JP)

(73) Assignee: Yazaki Corporation, Tokyo (JP)

(21) Appl. No.: 13/257,757

(22) PCT Filed: Mar. 9, 2010
(86) PCT No.: PCT/JP2010/053851

§ 371 Date: Sep. 20, 2011

(30) Foreign Application Priority Data
Mar. 25, 2009 (JP) 2009 073129

(51) Int. Cl. B23K 11/00

(52) U.S. Cl. 219/117.1; 219/78.01

(57) ABSTRACT

[Problem] To provide a metal connecting method and a metal connecting device to prevent a shot-circuit between the core wire and the shield portion by preventing the insulating inner coat from melting, and to surely connect the shield portion and the conductive member to each other.

[Means for solving problem]

The ground terminal 4 is wound around an outer periphery of the coaxial cable 3. A portion of the ground terminal 4 wound around the coaxial cable 3 is clipped between the pair of electrodes 11, 12. While the pair of electrodes 11, 12 is pressed in a direction close to each other, a current is applied to the pair of electrodes 11, 12. The current of a predetermined current value is applied for a predetermined time so that the insulating outer coat 34 is heated more than the melting point of the insulating outer coat 34, the braided wire 33 and the ground terminal 4 are connected to each other, and the insulating inner coat 32 is heated less than the melting point of the insulating inner coat 32.

### TECHNICAL FIELD

This invention relates to a metal connecting method and a metal connecting device for connecting a shield portion of a shielded wire to a conductive member.

### BACKGROUND ART

For example, when a core wire of a covered wire having the conductive core wire and an insulating cover for covering the core wire is connected to a terminal as a conductive member, a well-known resistance welding device may be used. This resistance welding device includes a pair of electrodes. A plurality of objects to be connected is clipped between the pair of electrodes, the pair of electrodes is pressed in a direction close to each other, and a current is applied to the pair of electrodes. Resultingly, the objects to be connected are heated to be melted, thereby the objects to be connected are connected to each other.

When connecting the core wire of the covered wire to the terminal using the above-described resistance welding device, for example, a wire connecting portion of the terminal may be formed by bending an outer edge of the terminal in a substantially C-shaped section (substantially U-shaped section) (for example, see Patent Documents 1 and 2). Then, this wire connecting portion is wound around an outer periphery of the covered wire, a part of the wire connecting portion wound around the covered wire is clipped between the pair of electrodes, the pair of electrodes is pressed and a current is applied to the pair of electrodes.

Then, due to the above-described resistance heat generation of the wire connecting portion, the cover is heated more than the melting point of the cover. At this time, because the pair of electrodes is pressed in the direction close to each other, the melted cover is pushed out from between the wire connecting portion and the core wire, and the core wire contacts the wire connecting portion. Then, the core wire and the wire connecting portion are melted and connected to each other, thereby the core wire and the terminal are connected to each other.

By connecting the covered wire and the terminal in this way, a process of previously peeling the cover to expose the core wire is unnecessary, and the workability is increased. Further, compared to a case that the terminal is crimped after the core wire is exposed, the terminal can be surely closely attached to the core wire. Therefore, the terminal and the core wire are prevented from corrosion, and an electric contact between the terminal and the core wire is stabilized for a long time.

### PRIOR ART DOCUMENT

### Patent Document

Patent Document 1: JP, A, 2007-73476
Patent Document 2: JP, A, 2006-31980

### DISCLOSURE OF THE INVENTION

### Problem to be Solved by the Invention

Meanwhile, the inventor of the present invention thinks of using the above-described resistance welding device for connecting a shielded wire to a ground terminal as a conductive member. The shielded wire includes: a conductive core wire; an insulating inner coat for covering the core wire; a braided wire as a conductive shield portion for covering the insulating inner coat; and an insulating outer coat for covering the braided wire. The ground terminal includes the above-described wire connecting portion. By electrically connecting the wire connecting portion to the braided wire, an electric noise shielded by the braided wire is transferred to the ground.

When connecting the shielded wire to the ground terminal using the above-described resistance welding device, similar to the above-described case that the covered wire is connected to the terminal, the wire connecting portion of the ground terminal is wound around an outer periphery of the shielded wire, a part of the wire connecting portion wound around the shielded wire is clipped between the pair of electrodes, the pair of electrodes is pressed and a current is applied to the pair of electrodes. Thereby, the insulating outer coat is heated more than the melting point of the insulating outer coat, the melted insulating outer coat is pushed out from between the wire connecting portion and the braided wire, and the braided wire contacts the wire connecting portion. Then, the braided wire and the wire connecting portion are connected to each other, and the braided wire, namely, the shielded wire and the ground terminal are connected to each other.

However, when the shielded wire is connected to the ground terminal as described above, there is a problem that the insulating inner coat may be heated more than the melting point of the insulating inner coat. Further, when the insulating inner coat is melted, there is a problem that the braided wire and the core wire may be short-circuited to each other. Therefore, the conventional above-described resistance welding device cannot be used for connecting the shielded wire to the ground terminal.

Accordingly, an object of the present invention is to solve such a problem. Namely, the object of the present invention is to provide a metal connecting method and a metal connecting device to prevent a shot-circuit between the core wire and the shield portion by preventing the insulating inner coat from melting, and to surely connect the shield portion and the conductive member to each other.

### Means for Solving the Problem

For attaining the object, according to the invention described in claim 1, there is provided a metal connecting method comprising the steps of:

clipping a shielded wire having a conductive core wire, an insulating inner coat for covering the core wire, a conductive shield portion for covering the insulating inner coat, and an insulating outer coat for covering the shield portion, and a conductive member between a pair of electrodes; and

applying a current to the pair of electrodes while the pair of electrodes is pressed in a direction close to each other to connect the shield portion and the conductive member to each other,

said method further comprising the steps of:

winding the conductive member to an outer periphery of the shielded wire;

clipping a portion of the conducting member wound around the shielded wire between the pair of electrode; and

applying a current to the pair of electrodes so as to heat the insulating outer coat more than the melting point of the insulating outer coat, and heat the insulating inner coat less than the melting point of the insulating inner coat.

According to the invention described in claim 2, there is provided the connection method as claimed in claim 1, further comprising the steps of:

calculating a predetermined period of time previously in an experiment for which upon applying a current of a predetermined current value to the pair of electrodes, the insulating outer coat is heated more than the melting point of the insulating outer coat and melted to connect the shield portion and the conductive member to each other, and the insulating inner coat is heated less than the melting point of the insulating inner coat and not melted; and

applying the current of the predetermined current value for the predetermined period of time to the pair of electrodes.

According to the invention described in claim 3, there is provided a metal connecting device for connecting a conductive shield portion of a shielded wire to a conductive member, said shielded wire having a conductive core wire, an insulating inner coat for covering the core wire, the conductive shield portion for covering the insulating inner coat, and an insulating outer coat for covering the shield portion, said metal connecting device comprising:

a pair of electrodes clipping a portion of the conductive member wound around an outer periphery of the shielded wire therebetween; and

a control member for controlling a current applied to the pair of electrodes in a manner that the insulating outer coat is heated more than the melting point of the insulating outer coat, and the insulating inner coat is heated less than the melting point of the insulating inner coat.

According to the invention described in claim 4, there is provided the metal connecting device as claimed in claim 3,

wherein the control member includes: a timer for measuring an elapsed time from a start of energizing the pair of electrodes; and a controller for applying a current of a predetermined current value to the pair of electrodes until the elapsed time measured by the timer is a predetermined time for which upon applying a current of the predetermined current value to the pair of electrode, the insulating outer coat is heated more than the melting point of the insulating outer coat and melted to connect the shield portion and the conductive member to each other, and the insulating inner coat is heated less than the melting point of the insulating inner coat and not melted.

### Effects of the Invention

According to the invention claimed in claim 1, the melted insulating outer coat is pushed out from between the shield portion and the conductive member, and the shield portion contacts the conductive member to connect the shield portion and the conductive member to each other. At this time, the insulating inner coat is not melted. Therefore, a short-circuit between the core wire and the shield portion is surely prevented, and the shield portion and the conductive member are surely connected to each other.

According to the invention claimed in claim 2, because the temperature of the shielded wire is managed by applying a current of a predetermined current value to the pair of electrodes for a predetermined period of time based on the data calculated previously in the experiment, a short-circuit between the core wire and the shield portion is surely prevented, and the shield portion and the conductive member are surely connected to each other.

According to the invention claimed in claim 3, the melted insulating outer coat is pushed out from between the shield portion and the conductive member, and the shield portion contacts the conductive member to connect the shield portion and the conductive member to each other. At this time, the insulating inner coat is not melted. Therefore, a metal connecting device able to surely prevent a short-circuit between the core wire and the shield portion and to surely connect the shield portion and the conductive member can be provided.

According to the invention claimed in claim 4, because the temperature of the shielded wire is managed using the timer and controller by applying a current of a predetermined current value to the pair of electrodes for a predetermined period of time based on the data calculated previously in the experiment, a metal connecting device able to surely prevent a short-circuit between the core wire and the shield portion and to surely connect the shield portion and the conductive member can be provided.

### BRIEF DESCRIPTION OF DRAWINGS

FIG. 1 An explanatory view showing a configuration of a device main body of a metal connecting device according to an embodiment of the present invention.

FIG. 2 A block diagram showing a configuration of the metal connecting device shown in FIG. 1.

FIG. 3 A perspective view showing a braided wire and a ground terminal connected by the metal connecting device shown in FIG. 1.

FIG. 4 A sectional view taken on line IV-IV in FIG. 3.

FIG. 5 A graph showing a relationship between an energizing time and a temperature when the braided wire and the ground terminal are connected to each other with the metal connecting device shown in FIG. 2.

FIG. 6 A sectional view showing the braided wire and the ground terminal shown in FIG. 2 positioned in between a pair of electrodes in a condition before connecting.

FIG. 7 A sectional view showing the braided wire and the ground terminal shown in FIG. 6 in a condition connected to each other.

FIG. 8 A flowchart showing a procedure performed by a controller of the metal connecting device shown in FIG. 2.

### DESCRIPTION OF EMBODIMENTS

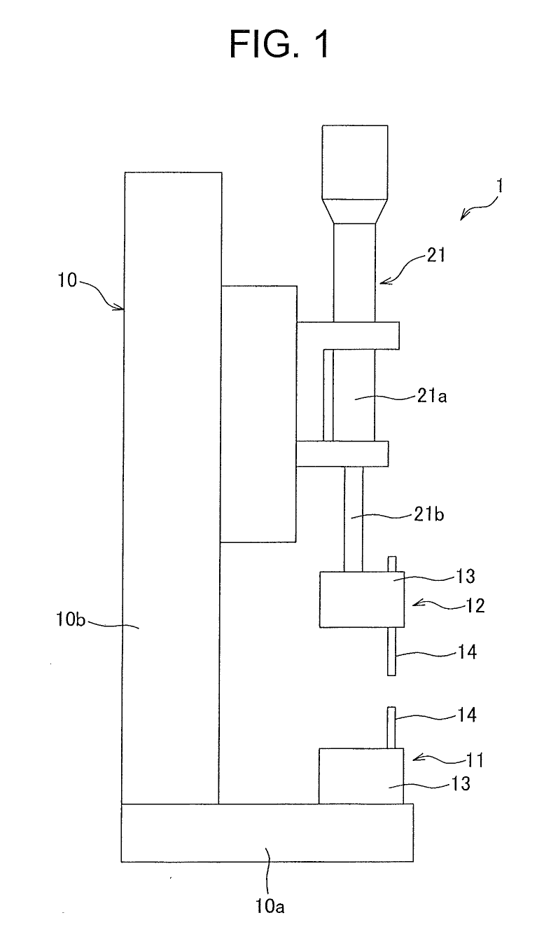

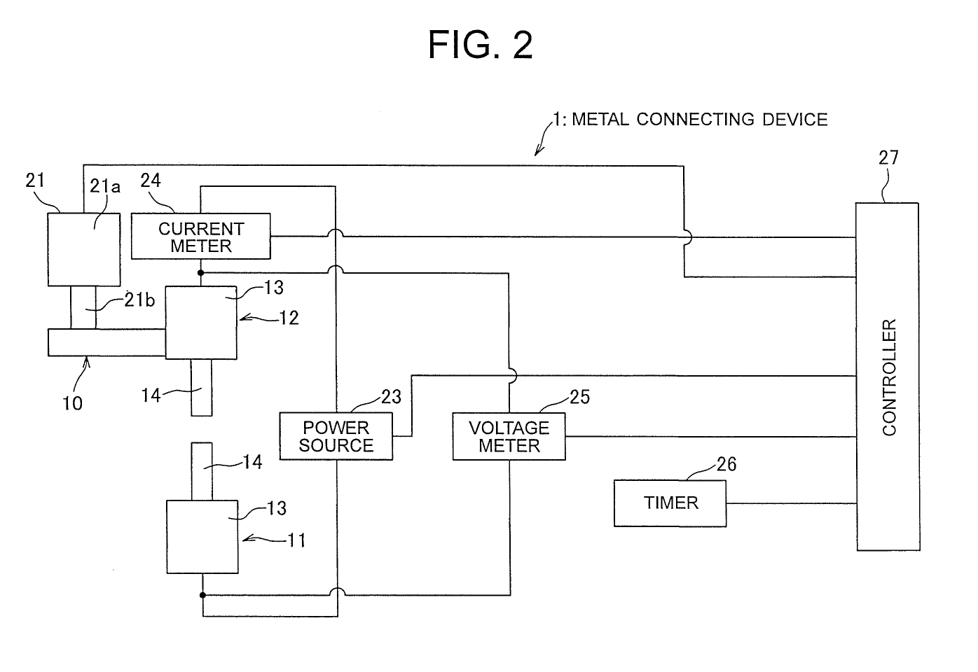

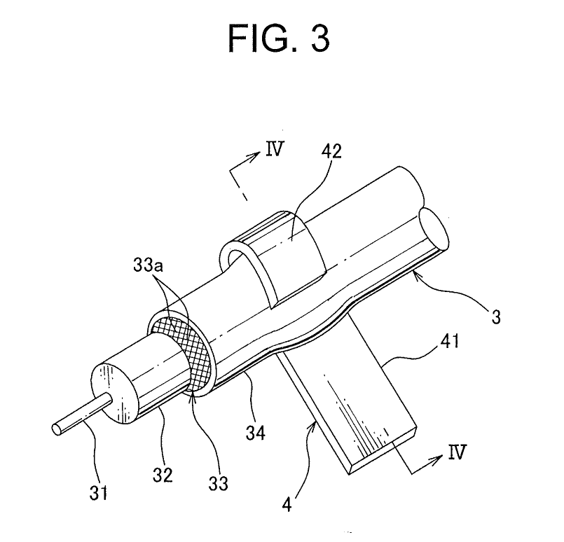

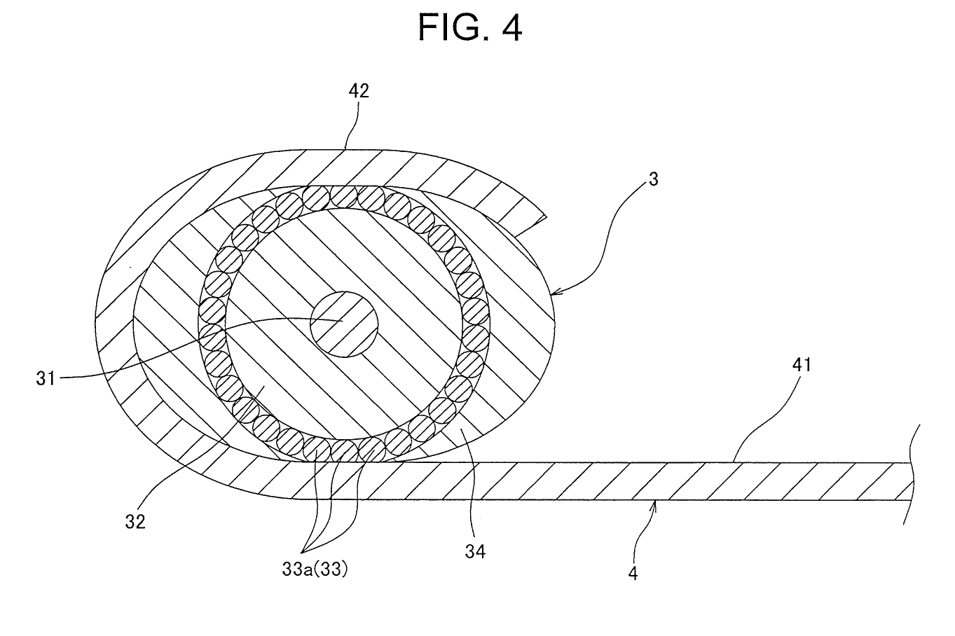

Hereinafter, a metal connecting device 1 according to an embodiment of the present invention will be explained with reference to FIGS. 1 to 7. The metal connecting device 1 according to an embodiment of the present invention as shown in FIGS. 1 and 2 is a device configured to connect a braided wire 33 (corresponding to a shield portion in claims) of a coaxial cable 3 (corresponding to a shielded wire in claims) as shown in FIGS. 3 and 4 to a ground terminal 4 (corresponding to a conductive member in claims) by resistance welding to mechanically and electrically connect the coaxial cable 3 to the ground terminal 4.

As shown in FIGS. 3 and 4, the coaxial cable 3 includes: a conductive core wire 31; an insulating inner coat 32 covering the core wire 31; a conductive braided wire 33 covering the insulating inner coat 32; and an insulating outer coat 34 covering the braided wire 33.

The core wire 31 is made of conductive metal such as copper. The core wire 31 is formed in a line shape having a circular section. Incidentally, the core wire 31 shown in FIGS. 3 and 4 is composed of a single wire, however, the core wire 31 may be composed of a plurality of wires stranded together.

The insulating inner coat 32 is made of insulating synthetic resin such as polyethylene. The insulating inner coat 32 covers a whole circumference of the core wire 31 along substantially a whole length of the core wire 31.

The braided wire 33 is made by braiding a plurality of elemental wires 33a and formed in a mesh shape. The elemental wire 33a is made of conductive metal such as copper. Further, the braided wire 33 is formed in a long tubular shape, and covers a whole circumference of the insulating inner coat 32 along substantially a whole length of the insulating inner coat 32. The braided wire 33 electromagnetically shields the core wire 31, and prevents an electrical noise from leaking from the core wire 31 to an outside of the braided wire 33, or prevents an electrical noise from entering the core wire 31 from an outside. Incidentally, the braided wire 33 may be a metal foil in a tubular shape made of a conductive metal formed in a foil shape.

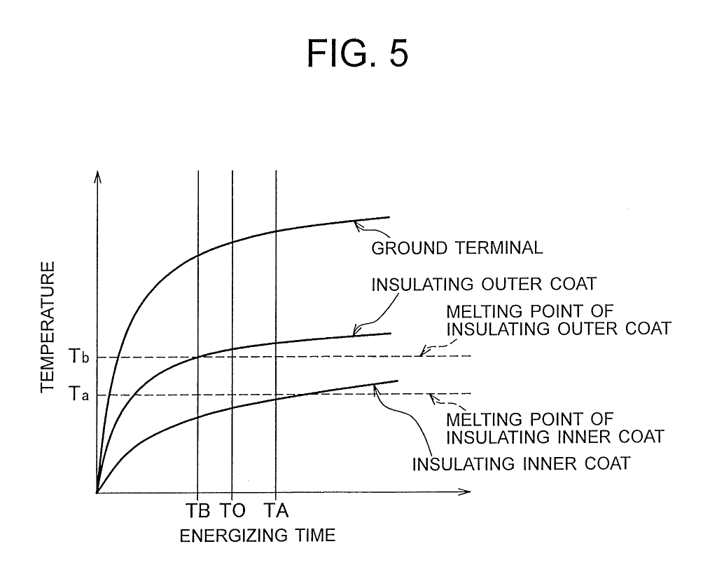

The insulating outer coat 34 is made of insulating synthetic resin. The insulating outer coat 34 is made of more burn-resistant polyethylene than the polyethylene of the insulating inner coat 32. Namely, as shown in FIG. 5, the melting point Tb of the insulating outer coat 34 is higher than the melting point Ta of the insulating inner coat 32. The insulating outer coat 34 is formed in a tubular shape, and covers a whole circumference of the braided wire 33 along substantially a whole length of the braided wire 33. Therefore, an outer periphery of the insulating outer coat 34 is an outer periphery of the coaxial cable 3.

The ground terminal 4 is made by pressing conductive metal or the like. Copper plating is given to a surface of the ground terminal 4. Preferably, the surface of the ground terminal 4 is made of the same metallic material as the braided wire 33. As shown in FIGS. 3 and 4, the ground terminal 4 integrally includes: a grounded portion 41 and a wire connecting portion 42.

The grounded portion 41 is formed in a rectangular flat plate shape. For example, the grounded portion 41 includes a not-shown through hole for screwing, and is screwed onto a body panel or the like of a vehicle to be fixed to the body panel, thereby the ground terminal 4 is grounded. Thus, the coaxial cable 3 electrically connected to the ground terminal 4 is grounded.

The wire connecting portion 42 is formed by bending an outer edge of the grounded portion 41 in substantially a C-shaped section (substantially a U-shaped section). An inner diameter of the wire connecting portion 42 is a little bit larger than an outer diameter of the coaxial cable 3 (an outer diameter of the insulating outer coat 34). The wire connecting portion 42 is wound around an outer periphery of the coaxial cable 3, and receives the coaxial cable 3 in an inside thereof. A part of an inner wall of the wire connecting portion 42 is electrically and mechanically connected to a part of an outer wall of the braided wire 33 by resistance welding. When the wire connecting portion 42 is electrically connected to the braided wire 33, an electrical noise shielded by the braided wire 33 is transferred to the ground via the grounded portion 41.

After the wire connecting portion 42 of the ground terminal 4 is wound around the outer periphery of the coaxial cable 3, and the coaxial cable 3 and the ground terminal 4, namely, the wound portion of the ground terminal 4 around the coaxial cable 3 is clipped between a pair of electrodes 11, 12, the metal connecting device 1 welds to connect the braided wire 33 and the wire connecting portion 42 of the ground terminal 4 to each other.

As shown in FIGS. 1 and 2, the metal connecting device 1 includes: a device main body 10; a cylinder 21; a power source 23; a current meter 24; a voltage meter 25; a timer 26; and a controller 27.

As shown in FIG. 1, the device main body 10 includes: a base plate 10a; a vertically extended plate 10b vertically extended from the base plate 10a; and the pair of electrodes 11, 12. The base plate 10a is formed in a thick plate shape, and installed on a floor or the like of a factory. The vertically extended plate 10b is extended upward from the base plate 10a.

Each of the pair of electrodes 11, 12 includes: a holder 13 and an electrode main body 14. The electrode main body 14 is formed in a bar shape, and attached to the holder 13. The holder 13 of the one electrode 11 is fixed to the base plate 10a, and extended upward from the base plate 10a. The electrode main body 14 of the one electrode 11 is attached to the holder 13 in a manner to be extended upward in a vertical direction from the holder 13.

While the electrode main body 14 of the one electrode 11 faces the electrode main body 14 of the other electrode 12 in a vertical direction, the holder 13 of the other electrode 12 is attached to a later-described rod 21b of the cylinder 21. The electrode main body 14 of the other electrode 12 is attached to the holder 13 in a manner to be extended downward in a vertical direction from the holder 13.

When the later-described rod 21b of the cylinder 21 is expanded, the electrode main bodies 14 of the pair of electrodes 11, 12 are moved close to each other. When the rod 21b of the cylinder 21 is contracted, the electrode main bodies 14 are moved away from each other. Thus, by expanding or contracting the rod 21b, the electrode main bodies 14 of the pair of electrodes 11, 12 are moved close to each other or away from each other.

As shown in FIG. 2, the power source 23 is connected to the controller 27, and applies a current (so-called welding current) to the pair of electrodes 11, 12 according to an instruction from the controller 27.

As shown in FIG. 2, the current meter 24 is interposed between the power source 23 and the other electrode 12, and electrically connected to them. Further, the current meter 24 is connected to the controller 27. The current meter 24 measures a current value of the above-described current, and outputs the current value to the controller 27.

As shown in FIG. 2, the voltage meter 25 is electrically connected to both of the pair of electrodes 11, 12. Further, the voltage meter 25 is connected to the controller 27. The voltage meter 25 measures a voltage value between the pair of electrodes 11, 12 upon applying the above-described current, and outputs the voltage value to the 27.

As shown in FIG. 2, the timer 26 is connected to the controller 27. The timer 26 is reset when a later-described reset signal is inputted from the controller 27. Further, when a later-described measurement start signal is inputted from the controller 27, the timer 26 starts measuring an elapsed time since the measurement start signal is inputted. The timer 26 constantly outputs data corresponding to the elapsed time as a pulse signal to the controller 27.

The controller 27 is a computer including: well-known ROM; RAM; CPU; and the like. The controller 27 is connected to the cylinder 21, the power source 23, the current meter 24, the voltage meter 25, the timer 26, and the like, and controls the whole metal connecting device 1.

The controller 27 makes the rod 21b of the cylinder 21 expand to clip the wire connecting portion 42 of the ground terminal 4 wound around the coaxial cable 3 between the pair of electrodes 11, 12. Then, the controller 27 makes the cylinder 21 press the grounded portion 41 with a predetermined force in a direction where the pair of electrodes 11, 12 are moved close to each other so as to press the coaxial cable 3 and the wire connecting portion 42 between the pair of electrodes 11, 12 in a direction close to each other.

Further, the controller 27 outputs an energization start signal to the power source 23 so as to apply a current to the pair of electrodes 11, 12 while the pair of electrodes 11, 12 are pressed as described above. The controller 27 keeps the current of the power source 23 in a predetermined current value according to the current value from the current meter 24.

Further, the controller 27 outputs the reset signal to the timer 26 for resetting the timer 26, and outputs the energization start signal and the measurement start signal at the same time to make the timer 26 measure the elapsed time since the measurement start signal is inputted.

Further, the controller 27 stores a later-described predetermined time TO. When the controller 27 judges that the elapsed time from the timer 26 reaches the predetermined time TO, the controller 27 outputs an energization stop signal to the power source 23 so as to stop energizing of the power source 23, and stops pressing by the cylinder 21.

As shown in FIG. 5, the predetermined time TO indicates a time when the insulating outer coat 34 is heated more than the melting point Tb of the insulating outer coat 34 and melted, the braided wire 33 and the ground terminal 4 are heated more than respective melting points and welded to be connected to each other, and the insulating inner coat 32 is heated less than the melting point Ta of the insulating inner coat 32 and not melted, upon applying the current of the predetermined current value to the pair of electrodes 11, 12 clipping the ground terminal 4 wound around the coaxial cable 3 in the metal connecting device 1.

The above-described predetermined time TO is decided according to material and shapes of the insulating inner coat 32, the braided wire 33, and the insulating outer coat 34 of the coaxial cable 3, material and a shape of the ground terminal 4, the current value, and the like. In this embodiment, the predetermined time TO is derived from a graph shown in FIG. 5 which is generated by measuring temperature (vertical axis) of the insulating inner coat 32 and the insulating outer coat 34 per energization time (horizontal axis) when the current of predetermined current value is applied to the pair of electrodes 11, 12 using the metal connecting device 1 and the connecting objects of the coaxial cable 3 and the ground terminal 4 previously in an experiment. The predetermined time TO can be an arbitrary time within a range “TB<TO<TA” in FIG. 5. Incidentally, the predetermined time TO may be derived from calculation.

Typically, when the resistance welding is done, respective calorific values Q(J) of the parts (the insulating inner coat 32, the insulating outer coat 34, or the like) of the coaxial cable 3, and the ground terminal 4 is indicated by

Q=R×I²×t

where the resistance of the parts of the coaxial cable 3 and the ground terminal 4 is R(Ω), the welding current is I(A), and the energization time is t(s). As shown in the above formula, when changing the predetermined time TO or the predetermined current value, the calorific values of the parts of the coaxial cable 3 and the ground terminal 4 are changed. Therefore, even if the material or the shape different from the coaxial cable 3 or the ground terminal 4 of this embodiment, and the shielded wire other than the coaxial cable, conductive member other than the ground terminal are used, the metal connecting device 1 can heat the insulating outer coat more than the melting point of the insulating outer coat, heat the shield portion and the conductive member more than the melting points of those, and heat the insulating inner coat less than the melting point of the insulating inner coat.

Thus, by applying the current from the output of the energization start signal to the output of the energization stop signal (namely, for the predetermined time TO), the controller 27 controls the current applied to the pair of electrodes 11, 12 so that the insulating outer coat 34 is heated more than the melting point Tb of the insulating outer coat 34, the braided wire 33 and the ground terminal 4 are heated more than the respective melting points (around the melting points) thereof, and the insulating inner coat 32 is heated less than the melting point Ta of the insulating inner coat 32. The timer 26 and the controller 27 are components of the control member claimed in claims.

Then, the braided wire 33 of the coaxial cable 3 and the wire connecting portion 42 of the ground terminal 4 are resistance-welded and connected to each other in a predetermined quality by the controller 27 according to the current value from the current meter 24 and the voltage value from the voltage meter 25.

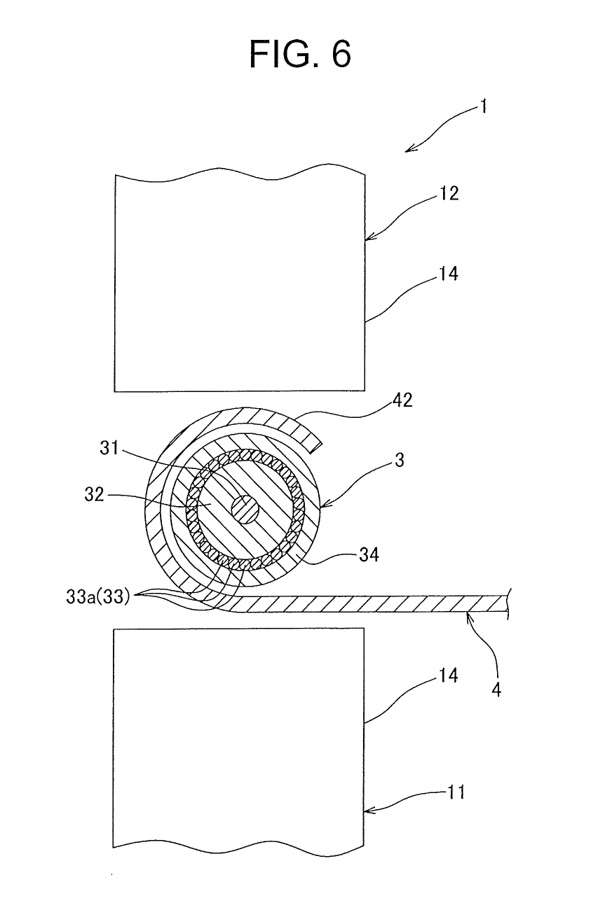

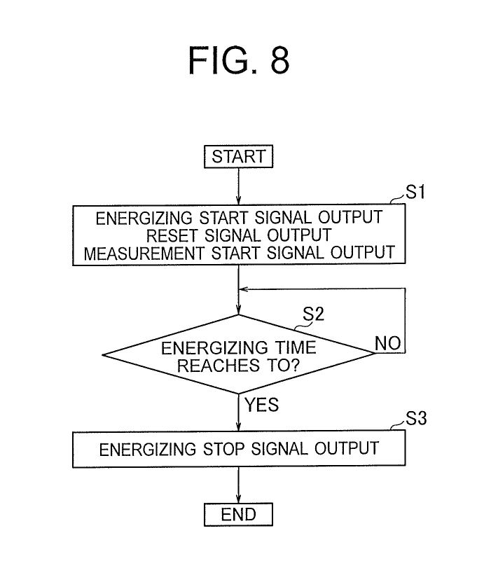

A method for connecting the braided wire 33 of the coaxial cable 3 to the ground terminal 4 using the above-described metal connecting device 1 will be explained with reference to a flowchart of FIG. 8. First, the wire connecting portion 42 of the ground terminal 4 is wound around the coaxial cable 3 at a predetermined position in a longitudinal direction. Then, as shown in FIG. 6, the wound portion of the ground terminal 4 around the outer periphery of the coaxial cable 3, namely, the wire connecting portion 42 is clipped between the electrode main bodies 14 of the pair of electrodes 11, 12.

Then, the controller 27 makes the rod 21b of the cylinder 21 expand to press the pair of electrodes 11, 12 in a direction close to each other by a predetermined force, and outputs the energization start signal to the power source 23 to apply the current of the predetermined current value to the pair of electrodes 11, 12. Further, the controller 27 outputs the reset signal and the measurement start signal to the timer 26, and makes the timer 26 measure the elapsed time since the input of the measuring start signal, namely, the elapsed time since the energization start to the pair of electrodes 11, 12 (step S1 of the flowchart in FIG. 8).

Then, the current is applied to the pair of electrodes 11, 12 via the wire connecting portion 42 of the ground terminal 4, and the wire connecting portion 42 is resistance heated. At this time, because a part of an inner wall of the wire connecting portion 42 and a part of an outer wall of the insulating outer coat 34 contact each other by the application of pressure, the resistance heat generated inside of the wire connecting portion 42 is thermally transferred to the outer wall of the insulating outer coat 34, and the insulating outer coat 34 is heated. Then, the insulating outer coat 34 is heated more than the melting point Tb of the insulating outer coat 34.

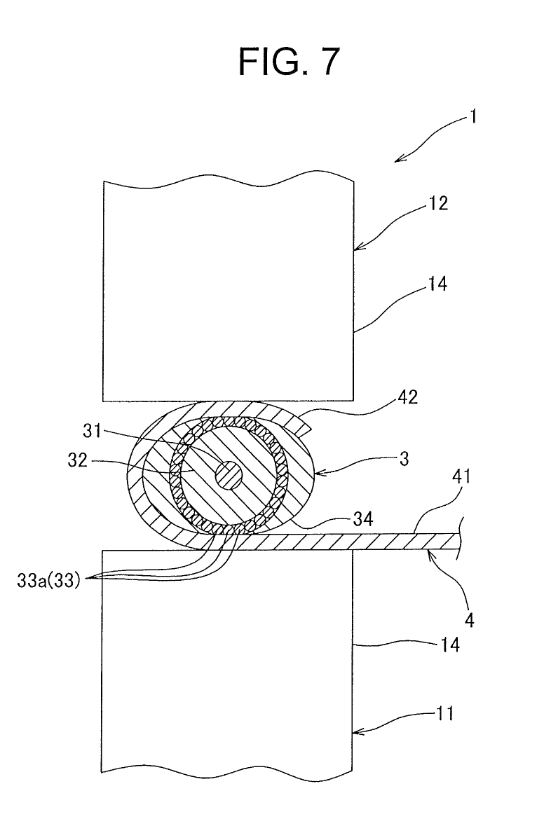

Then, the melted insulating outer coat 34 is pushed out from between the wire connecting portion 42 and the braided wire 33 due to the application of pressure, the pair of electrodes 11, 12 is gradually moved close to each other, and the inner wall of the wire connecting portion 42 and a part of the outer wall of the braided wire 33 contact each other. Then, the current is applied to the pair of electrodes 11, 12 via the wire connecting portion 42 and the braided wire 33, and the braided wire 33 is also resistance heated. Then, the wire connecting portion 42 and the braided wire 33 are heated more than respective melting points, and as shown in FIG. 7, the inner wall of the wire connecting portion 42 and the outer wall of the braided wire 33 which contact each other are respectively melted.

Then, the controller 27 judges whether the elapsed time since the energization start reaches the predetermined time TO or not based on the data from the timer 26 (step S2 of the flowchart in FIG. 8), and when judging not (“NO” in step S2), the controller 27 judges again. Thus, such a judgement is repeated several times, and when judging that the elapsed time since the energization start reaches the predetermined time TO based on the data from the timer 26 (“YES” in step S2 of the flowchart in FIG. 8), the controller 27 outputs the energization stop signal to the power source 23 to stop energization of the power source 23, and to stop pressing of the cylinder 21 (step S3 of the flowchart in FIG. 8). At this time, the insulating inner coat 32 is heated by the heat generation of the braided wire 33 and the wire connecting portion 42, however, because the insulating inner coat 32 is separated away from the wire connecting portion 42 and the insulating outer coat 34, the insulating inner coat 32 is not heated to the melting point Ta of the insulating inner coat 32 (the insulating inner coat 32 is heated less than the melting point Ta of the insulating inner coat 32).

Then, the inner wall of the wire connecting portion 42 and the outer wall of the braided wire 33, which contact each other and are partially melted, are gradually cooled after the current is stopped, and gradually metallically bonded with each other. Thus, the wire connecting portion 42 and the braided wire 33 are connected to each other (mechanically fixed to each other) by the resistance welding, and the ground terminal 4 and the coaxial cable 3 are connected to each other by the resistance welding.

According to this embodiment, the melted insulating outer coat 34 is pushed out from between the braided wire 33 and the ground terminal 4, and the braided wire 33 and the ground terminal 4 contact each other, thereby the coaxial cable 3 and the ground terminal 4 are connected to each other. However, the insulating inner coat 32 is not melted. Therefore, a short-circuit between the core wire 31 and the braided wire 33 is surely prevented, and the braided wire 33 and the ground terminal 4 are surely connected to each other.

According to the embodiment described above, by using the above described metal connecting device 1, the wire connecting portion 42 and the braided wire 33 are heated more than the respective melting points to be melted, and the wire connecting portion 42 and the braided wire 33 are connected to each other by welding. However, according to the present invention, by using the above-described metal connecting device 1, the wire connecting portion 42 and the braided wire 33 may be heated at a temperature where the inner wall of the wire connecting portion 42 and the outer wall of the braided wire 33 are diffusion-bonded together, namely, heated less than the respective melting points and around the respective melting points, and the wire connecting portion 42 and the braided wire 33 may be diffusion-bonded without melting the wire connecting portion 42 and the braided wire 33.

Further, in the embodiment described above, the timer 26 measures the elapsed time since the measurement start signal is inputted, however, depending on the length of the predetermined time TO, an operator may measure the elapsed time, and when the elapsed time reaches the predetermined time TO, the operator may operate the controller 27 to stop pressing and stop energizing.

Further, in the embodiment described above, the coaxial cable 3 is used as an example of the shielded wire. However, the other shielded wire other than the coaxial cable 3 may be used. Further, in the embodiment described above, the ground terminal 4 is used as an example of the conductive member. However, a terminal or a metal plate other than the ground terminal 4 may be used.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

### REFERENCE SIGNS LIST

1 metal connecting device
3 coaxial cable (shielded wire)
4 ground terminal (conductive member)
11 one electrode
12 the other electrode
26 timer (control member)
27 controller (control member)
31 core wire
32 insulating inner coat
33 braided wire (shield portion)
34 insulating outer coat
Ta melting point of insulating inner coat
Tb melting point of insulating outer coat

1. A metal connecting method comprising the steps of:
clipping a shielded wire having a conductive core wire, an insulating inner coat for covering the core wire, a conductive shield portion for covering the insulating inner coat, and an insulating outer coat for covering the shield portion, and a conductive member between a pair of electrodes; and
applying a current to the pair of electrodes while the pair of electrodes is pressed in a direction close to each other to connect the shield portion and the conductive member to each other,
said method further comprising the steps of:
winding the conductive member to an outer periphery of the shielded wire;
clipping a portion of the conducting member wound around the shielded wire between the pair of electrode; and
applying a current to the pair of electrodes so as to heat the insulating outer coat more than the melting point of the insulating outer coat, and heat the insulating inner coat less than the melting point of the insulating inner coat.

2. The connection method as claimed in claim 1, further comprising the steps of:
calculating a predetermined period of time previously in an experiment for which upon applying a current of a predetermined current value to the pair of electrodes, the insulating outer coat is heated more than the melting point of the insulating outer coat and melted to connect the shield portion and the conductive member to each other, and the insulating inner coat is heated less than the melting point of the insulating inner coat and not melted; and
applying the current of the predetermined current value for the predetermined period of time to the pair of electrodes.

3. A metal connecting device for connecting a conductive shield portion of a shielded wire to a conductive member, said shielded wire having a conductive core wire, an insulating inner coat for covering the core wire, the conductive shield portion for covering the insulating inner coat, and an insulating outer coat for covering the shield portion, said metal connecting device comprising:
a pair of electrodes clipping a portion of the conductive member wound around an outer periphery of the shielded wire therebetween; and
a control member for controlling a current applied to the pair of electrodes in a manner that the insulating outer coat is heated more than the melting point of the insulating outer coat, and the insulating inner coat is heated less than the melting point of the insulating inner coat.

4. The metal connecting device as claimed in claim 3,
wherein the control member includes: a timer for measuring an elapsed time from a start of energizing the pair of electrodes; and a controller for applying a current of a predetermined current value to the pair of electrodes until the elapsed time measured by the timer is a predetermined time for which upon applying a current of the predetermined current value to the pair of electrode, the insulating outer coat is heated more than the melting point of the insulating outer coat and melted to connect the shield portion and the conductive member to each other, and the insulating inner coat is heated less than the melting point of the insulating inner coat and not melted.
